(19) United States
(12) Patent Application Publication
(10) Pub. No.: US 2021/0141628 A1
(43) Pub. Date: May 13, 2021

(54) AUTOMATED SYSTEM AND METHOD FOR UPDATING FIRMWARE ON INDUSTRIAL DEVICES

(71) Applicant: SIEMENS INDUSTRY, INC., Alpharetta, GA (US)

(72) Inventors: Francis C. GARRABRANT, Johnson City, TN (US); Harry A. BRIAN, JR., Piney Flats, TN (US); Sergey CHIBIZOV, Johnson City, TN (US)

(73) Assignee: Siemens Industry, Inc., Alpharetta, GA (US)

(21) Appl. No.: 17/042,395

(22) PCT Filed: May 11, 2018
(86) PCT No.: PCT/US2018/032252

§ 371 Date: Sep. 28, 2020

(51) Int. Cl. G06F 8/65; G06F 21/57; H04L 12/24; H04L 29/08

(52) U.S. Cl. CPC G06F 8/65; H04L 67/36; H04L 41/22; G06F 21/572

(57) ABSTRACT

An system (100) for updating firmware on an industrial device (130) includes a user interface device (110) storing a computer program (200) with executable instructions (210, 212, 214, 220, 222); one or more industrial devices (130) comprising firmware; and a communication network (120) interfacing with the user interface device (110) and the industrial device (130) and adapted to transmit data, wherein the computer program (200) of the user interface device (110) comprises instructions (210) to scan the communication network (120) and to identify an industrial device (130) that requires an update of the firmware, and wherein the computer program (200) of the user interface device (110) comprises further instructions (214) to update the firmware on the industrial device (130) via the communication network (120) after establishing communication with the industrial device (130). Further, a method (300) and a computer program (200) for updating firmware on industrial devices (130) are provided.

### BACKGROUND

### 1. Field

Aspects of the present disclosure generally relate to industrial systems and industrial devices, such as for example industrial automation devices, and more particularly to an automated system and method for updating firmware on industrial devices.

### 2. Description of the Related Art

Industrial devices, such as for example automation devices and systems, are used in different industrial fields to (automatically) perform a plurality of tasks, for example in a manufacturing process or an assembly line of production facility. Industrial devices can be for example interconnected components, such as for example sensors, actuators and control devices, within an automation system. The control devices can be for example programmable logic controllers (PLCs) for controlling and monitoring process parameters. For example, within an industrial automation system, one or more sensors may be communicatively coupled to one or more PLC(s) via one or more input/output (I/O) modules, e.g., a communication module. Via the I/O modules, the PLC(s) may control one or more devices such as, for example, a rheostat, a switch, a sequencer, a servo drive, a motor, and/or a valve etc. Furthermore, operator terminals provide interfaces to the automation system for monitoring, controlling and displaying information to an operator or end user. Operator terminals are also known as Human-Machine-Interface (HMI) devices which allow effective operation and control of the components and devices of the automation system from the human end, i.e. the operator or end user, while the components/devices of the automation system feed information back to the operator/end user.

Industrial devices, such as for example modules of PLCs, HMI devices, drives, switches etc., typically comprise (micro-) controllers or integrated circuits of various kinds, i.e., generally, processor circuitries, and corresponding firmware for executing specific applications. Firmware is a specific class of software that provides control for the device's specific hardware and is stored in non-volatile memories.

Firmware of industrial devices, or generally devices that comprise firmware, such as embedded systems, may need to be updated from time to time because for example applications or programs executed by the firmware have been improved or modified. Another reason to update firmware is for security purposes, for example to address reported (usually by a vendor) security weakness or issues.

Known firmware update processes on industrial and embedded systems include manual steps and a diverse set of tools. This procedure is time-consuming and error-prone. In an example, to update a device, one may need to perform the following steps:
connect to a device via vendor specific engineering tool or other network accessible interface to identify current firmware version,
manually (one device at a time) search vendor website for available patches and updates,
manually (one device at a time) download latest firmware patch or update,
manually (one device at a time) apply the patch or update via engineering tool,
manually (one device at a time) confirm that patch or update is applied correctly via engineering tool.

Thus, there exists a need for an improved system and method for updating firmware, for example updating firmware on multiple devices.

### SUMMARY

Briefly described, aspects of the present disclosure relate to an automated system and method for updating firmware on industrial devices.

A first aspect of the present disclosure provides an automated system for updating firmware on an industrial device, the system comprising: a user interface device storing a computer program with executable instructions; one or more industrial devices comprising firmware; and a communication network interfacing with the user interface device and the industrial device and adapted to transmit data, wherein the computer program of the user interface device comprises instructions to scan the communication network and to identify at least one industrial device that requires an update of the firmware, and wherein the computer program of the user interface device comprises further instructions to update the firmware on the at least one industrial device via the communication network after establishing communication with the industrial device.

A second aspect of the present disclosure provides an automated method for updating firmware on an industrial device, the method comprising: scanning a communication network to identify an industrial device that requires updating of firmware on the industrial device; acquiring update files for the updating of the firmware; establishing communication to the industrial device via the communication network; and updating the firmware on the industrial device via the communication network utilizing the update files.

A third aspect of the present disclosure provides a computer program embodied in a non-transitory computer-readable medium comprising: instructions to scan a communication network to identify an industrial device requiring a firmware update, instructions to acquire update files for the firmware update, instructions to establish communication to the industrial device via the communication network; and instructions to perform the firmware update on the industrial device via the communication network.

### BRIEF DESCRIPTION OF THE DRAWINGS

FIG. 1 illustrates a schematic diagram of an automated system for updating firmware on industrial devices in accordance with an exemplary embodiment of the present disclosure.

FIG. 2 illustrates a schematic diagram of a computer program for updating firmware on industrial devices in accordance with an exemplary embodiment of the present disclosure.

FIG. 3 illustrates a flow chart of an automated method for updating firmware on industrial devices in accordance with an exemplary embodiment of the present disclosure.

### DETAILED DESCRIPTION

To facilitate an understanding of embodiments, principles, and features of the present invention, they are explained hereinafter with reference to implementation in illustrative embodiments. In particular, they are described in the context of industrial devices and systems, and more particularly in the context of systems, methods and computer readable media for updating firmware on industrial devices. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

FIG. 1 illustrates a schematic diagram of a system 100 for updating firmware on devices in accordance with an exemplary embodiment of the present disclosure. The system 100 comprises a user interface device 110, a communication network 120, and one or more devices 130.

The user interface device 110 is a computing device comprising a screen 114 and a memory device 112 storing a computer program 200 with executable instructions, such as program modules. Generally, program modules include routines, programs, programming, objects, components, data, data structures, and the like that perform particular tasks or implement particular abstract data types.

The user interface device 110 can be for example a touch screen device, a tablet, smart phone, personal computer, laptop computer or the like, with storage and wireless capabilities. The memory device 112 of the user interface device 110 is configured as non-volatile, removable, and/or non-removable medium implemented in many methods or technologies for storage of information such as computer-readable instructions, data, data structures, program modules, programs, programming, or routines.

The one or more devices 130 are herein referred to as industrial devices 130. The one or more industrial devices 130 is/are component(s) of a system, specifically an industrial system, such as an automation system, wherein the industrial devices 130 comprise hardware and software and can be interconnected components of an automation system. For example, the industrial devices 130 can include a sensor, an actuator, a valve, a drive, a field device, a switch, an electric machine such as a motor, a control device such as a programmable logic controller (PLC), a remote input/output (I/O) module, a human machine interface (HMI) device, or other computing device, such as for example a terminal computer, operator panel or inter-process communication (IPC). FIG. 1 illustrates some examples of industrial devices 130, such as PLCs 132, HMI devices 134 and switches 136.

The communication network 120 interfaces with the user interface device 110 and the industrial devices 130 and is adapted to transmit data. According to an exemplary embodiment, the communication network 130 is an industrial network. The devices 130 and optional further components, such as for example the user interface device 110, are interconnected via the industrial network 120 for communication purposes. The industrial devices 130 and further components can be connected wirelessly and/or wired within the industrial network 120.

Industrial networks used in an industrial environment include protocols that provide determinism and real-time control. For example, industrial Ethernet (IE) is the use of Ethernet in an industrial environment with protocols that provide determinism and real-time control. According to an exemplary embodiment, the industrial network 120 comprises industrial Ethernet and operates according to PROFINET protocol. But many other protocols for Industrial Ethernet (1E) may be used, for example EtherCAT, EtherNet/IP, POWERLINK, etc.

In an alternative embodiment, the communication network 120 may not be an industrial network, but a network such as for example the Internet or local area networks, or many other network environments that are accessible via an air interface, e.g. Wi-Fi.

FIG. 2 illustrates a schematic diagram of a computer program 200 for updating firmware on industrial devices 130 in accordance with an exemplary embodiment of the present disclosure.

As described before, industrial devices 130, such as for example modules of PLCs, HMI devices, drives, switches etc., typically comprise (micro-) controllers or integrated circuits of various kinds, i.e., generally, processor circuitries, and corresponding firmware for executing specific applications. Firmware is a specific class of software that provides control for the device's specific hardware and is stored in non-volatile memories. Firmware of industrial devices, or generally devices that comprise firmware, such as embedded systems, may need to be updated.

As illustrated in FIG. 1, the user interface device 110 comprises memory device 112 storing computer program 200 with executable instructions, such as for example program modules. Specifically, the computer program 200 includes instructions for performing an automated update of firmware on the industrial devices 130.

With further reference to FIG. 2, in an exemplary embodiment, the computer program 200 of the user interface device 110 comprises program modules 202 and 204. Each module 202, 204 comprise instructions, routines etc. to perform specific tasks or objectives. It should be noted that the program 200 may comprise more or less program modules 202, 204. For example, modules 202, 204 may be combined in one module.

The computer program 200, for example within module 202, comprises instructions 210 to scan the communication network 120 and to identify at least one industrial device 130 that requires an update (also referred to as patch) of the firmware on the industrial device 130. For example, the communication network 120 is scanned and all industrial devices 130 connected with the communication network 120 are identified. Some of the identified devices 130 may need a firmware update and some may not.

Current firmware version information of all identified devices 130 is collected. For example, the computer program 200, for example within module 202, comprises instructions 212 to generate an inventory list. The inventory list may list information relating to the current firmware versions of all identified devices 130.

As FIG. 2 further illustrates, the described system and method further comprise a database 250, which comprises all or most of update files or patches with respect to the firmware of the identified industrial devices 130. The database 250 can be an external database stored or hosted on a separate computer, for example by a firmware provider. In an example, the firmware provider may utilize cloud storage, wherein the update files 260 are stored for example on a server owned and managed by the firmware provider, and the update files 260 can be accessed for example via a cloud storage gateway.

The computer program 200, specifically module 204, is configured to access the database 250 and the update files 260. The program module 204 comprises instructions 220 to acquire update files 260 from the database 250 based on the inventory list previously generated when scanning the network 120. For example, module 204 may be configured such that the current firmware versions listed in the inventory list are checked or compared with available update files 260 of the database 250 to determine whether firmware update files 260 are available with respect to the identified devices 130. This means, that the program 200 includes functionality to associate available patches or update files 260 with the information collected during the network scan.

The inventory list comprising current firmware versions of all identified devices 130 is supplemented or complemented with available patches or update files 260. For example, there may be updated files 260 available for all identified devices 130 or only for some identified devices 130. The inventory list indicates which devices 130 can be updated with respect to firmware.

In an exemplary embodiment, the inventory list comprising information relating to current firmware versions and available update files 260 of the devices 130 is displayed on screen 114 of the user interface device 110 to a user. Further, the user can be provided with a flexible device update selection. For example, the user may select which firmware versions of which devices 130 should be updated.

After selection of available update files 260 by the user, the module 204 is configured to acquire and/or download the corresponding update files 260. The computer program 200, specifically module 204, comprises further instructions 222 to verify integrity of the update files 260. For example, integrity may be verified by determining that the update files 260 are not faulty and/or compatible with the identified industrial devices 130.

After the update files 260 are acquired and verified, module 202 comprises instructions 214 to update the firmware for those industrial devices 130, that were identified during the network scan, firmware update files 260 are available and selected to be updated by the user. The module 202 is configured to update the firmware via the communication network 120 after establishing communication with the corresponding industrial devices 130.

In an exemplary embodiment, upon completion of the firmware update(s), a report can be generated comprising for example identification (ID) of the devices 130 that were updated, performed operations, timestamps and firmware versions. Of course, such a report may comprise other data/information and can be modified as required. The report can be displayed to the user on the user interface device 110.

FIG. 3 illustrates a flow chart of a method 300 for updating firmware on industrial devices 130 in accordance with an exemplary embodiment of the present disclosure. The method 300 provided herewith refers to the components and elements as described before with reference to FIG. 1 and FIG. 2.

In an example, a user may want to perform firmware updates of industrial devices 130 connected with communication network 120. The user starts computer program 200 comprising multiple instructions 210, 212, 214, 220, 222. After activating the program 200, in a first step 310, a network scan of the communication network 120 is performed to identify industrial device(s) 130 that are connected with the network 120 and may need a patch or update of the firmware on the industrial device 130. An inventory list may be generated comprising information/data of current firmware versions of all identified devices 130.

Database 250 comprising patches or update files 260 is accessed and available patches or update files 260 are associates with the information/data of firmware versions collected during the network scan and provided in the inventory list. The inventory list is now supplemented or modified with the available patches or update files 260. The complete list is then displayed to the user via screen 114 of the user interface device 110. The method 300 is configured such that the user can select if all available patches or update files 260 should be applied or if only some firmware updates should be applied. After selecting which devices 130 should be updated, in step 320, the corresponding update files 260 are acquired, for example downloaded to user interface device 110, from the database 250 and verified.

In step 330, communication to those industrial devices 130 which are to be updated is established via the network 120, and, in step 340, the firmware on the industrial devices is updated via the network 120 and utilizing the update files 260. Upon completion of the updating 340, a report is created and displayed to the user comprising for example IDs of devices 130, performed operations, timestamps and firmware versions.

It should be appreciated that the described method 300 can comprise more steps, or some steps can be repeated multiple times, or some steps are optional. For example, displaying the inventory list to the user can be optional and the method 300 configured such that the updating is performed for all available patches/update files 260 automatically.

The described system 100, computer program 200 and method 300 provide a single, easy to use and fully automated solution for updating firmware on devices 130. Specifically, multiple devices 130 can be updated simultaneously. Further, user errors are reduced and a unified firmware update process across multiple device families including an improved documentation of the update process is provided.

1.-15. (canceled)

16. An automated system for updating firmware on an industrial device, the system comprising:
a user interface device storing a computer program with executable instructions;
one or more industrial devices comprising firmware; and
a communication network interfacing with the user interface device and the industrial device and adapted to transmit data,
wherein the computer program of the user interface device comprises instructions to scan the communication network and to identify at least one industrial device that requires an update of the firmware, and
wherein the computer program of the user interface device comprises further instructions to update the firmware on the at least one industrial device via the communication network after establishing communication with the industrial device.

17. The system of claim 16, wherein the one or more industrial devices are selected from a programmable logic controller, a human machine interface device, a switch, an electric machine, a sensor, an actuator, and a combination thereof.

18. The system of claim 16, wherein the communication network is an industrial network comprising one or more industrial Ethernet protocols.

19. The system of claim 16, wherein the user interface device is selected from a desktop computer, a tablet, a smart phone, and a handheld computing device.

20. The system of claim 16, wherein the computer program of the user interface device comprises further instructions to generate an inventory list comprising current firmware versions and/or update files for the at least one industrial device.

21. The system of claim 20, wherein the computer program comprises further instructions to acquire the update files based on the inventory list.

22. The system of claim 21, further comprising an external database comprising the update files, the computer program being configured to access the external database.

23. The system of claim 20, wherein the computer program of the user interface device comprises further instructions to verify integrity of the update files.

24. An automated method for updating firmware on an industrial device, the method comprising:
scanning a communication network to identify an industrial device that requires updating of firmware on the industrial device;
acquiring update files for the updating of the firmware;
establishing communication to the industrial device via the communication network; and
updating the firmware on the industrial device via the communication network utilizing the update files.

25. The automated method of claim 24, further comprising:
generating an inventory list comprising the update files required for updating the firmware on the industrial device.

26. The automated method of claim 25, further comprising:
verifying integrity of the update files of the inventory list.

27. The automated method of claim 24, wherein the industrial devices is selected from a programmable logic controller, a human machine interface device, a switch, an electric machine, a sensor, an actuator, and a combination thereof.

28. The automated method of claim 24, wherein the communication network is an industrial network comprising one or more industrial Ethernet protocols.

29. A computer program embodied in a non-transitory computer-readable medium comprising:
instructions to scan a communication network to identify an industrial device requiring a firmware update,
instructions to acquire update files for the firmware update,
instructions to establish communication to the industrial device via the communication network; and
instructions to perform the firmware update on the industrial device (130) via the communication network.

30. The computer program of claim 29, wherein the non-transitory computer-readable medium is stored in a memory of a user interface device.
